(19) United States
(12) Patent Application Publication
(10) Pub. No.: US 2022/0332618 A1
(43) Pub. Date: Oct. 20, 2022

(54) Water Treatment and Filtration System for Reducing Disinfection Byproducts

(71) Applicant: Julie L. Guimond, Flagler Beach, FL (US)

(72) Inventor: Julie L. Guimond, Flagler Beach, FL (US)

(21) Appl. No.: 17/721,329

(22) Filed: Apr. 14, 2022

Related U.S. Application Data
(60) Provisional application No. 63/175,039, filed on Apr. 14, 2021.

(51) Int. Cl. C02F 9/00; C02F 1/00

(52) U.S. Cl. CPC C02F 9/00; C02F 1/006; C02F 1/004; C02F 1/50

(57) ABSTRACT

An exemplary, nonlimiting embodiment of the present invention relates to a water treatment and filtration system for reducing the concentration disinfection byproducts within drinking water treated by municipal drinking water treatment plants. This water treatment and filtration system reduces the concentration of disinfection byproducts, which may include trihalomethanes (THM) and haloacetic acids (HAA5), in drinking water using a clever sequencing of treatment techniques that intentionally promote formation of the disinfectant byproducts prior to filtration to effectively remove disinfection byproduct precursors and prevent subsequent formation of disinfection byproducts downstream during distribution. Moreover, this water treatment and filtration system can be retrofitted to a variety of municipal drinking water treatment plants and is designed to easily scale if demand for drinking water within the municipality increases.

### CROSS-REFERENCE TO RELATED APPLICATIONS

This application claims the benefit of U.S. Provisional Application No. 63/175,039, filed Apr. 14, 2021, which is hereby incorporated by reference in its entirety for all purposes.

### FIELD OF THE INVENTION

This invention relates generally to a water treatment and filtration system which can be installed, or retrofitted, within a municipal drinking water treatment plant.

### BACKGROUND

It is well known that contaminants in of our drinking water pose significant health hazards. Municipal drinking water treatment plants strive to remove contaminants using numerous treatment and filtration systems. Chlorination has proven to be an effective pathogen inactivation technology for water treatment and has long been established as a bedrock treatment process within municipal drinking water treatment plants. However, it is also known that chlorination may result in the formation of disinfection byproducts (“DBPs”), which have been linked to carcinogenic effects. The Environmental Protection Agency (“EPA”) has established maximum concentration levels (“MCLs”) for a variety of different contaminants and disinfection byproducts (“DBPs”) in drinking water via the Safe Drinking Water Act. However, since effectuation of such regulatory standards, many municipal drinking water treatment plants have struggled to adequately reduce the concentration of DBPs in their water systems. Failure by a municipal water treatment plant to satisfy the maximum concentration levels for the variety of DBPs that are regulated by the EPA leads to costly oversight and operational modifications as well as elevated health risks for the general public. Moreover, failure by municipal drinking water treatment plants to adequately prevent DBPs in the drinking water supply have led many households and end users of drinking water treated by municipal drinking water treatment plants to install costly point-of-use treatment systems within their homes to filter DBPs. While several treatment techniques, such as UV germicidal irradiation and reverse osmosis, have been used to reduce DBP formation, such treatment techniques are either cost-prohibitive or lack sufficient efficacy for widespread adoption.

What is needed is an economical and effective treatment and filtration system for reducing DBPs in the public water supply.

### BRIEF SUMMARY OF THE INVENTION

An exemplary, nonlimiting embodiment of the present invention relates to a novel water treatment and filtration system for reducing disinfection byproducts, hereinafter the “DBP treatment system”, which reduces the concentration levels of a variety of disinfection byproducts in drinking water at its point-of-use. The DBP treatment system substantially reduces the concentration of the disinfection byproducts in the drinking water at its point-of-use by utilizing clever water treatment and filtration techniques prior to a municipal drinking water treatment plant, hereinafter the “MDWTP”, discharging the drinking water into its water distribution system. The DBP treatment system can be retrofitted within an existing MDWTP that may already be using a variety of conventional treatment processes, such as coagulation, flocculation, sedimentation, filtration, and disinfection.

The DBP treatment system incorporates a unique pre-chlorination phase, which takes place preferably near each of the MDWTP's one or more influent sources. The pre-chlorination phase comprises the execution of a pre-chlorination treatment, which is utilized as a means to deliberately form DBPs before and during a subsequent intermediate treatment phase. The intermediate treatment phase comprises the execution of one or more intermediate treatment processes, which may comprise one or more physical or chemical treatments that may include coagulation, flocculation, or sedimentation. The intermediate treatment phase precedes a carbon filtration phase, which utilizes a modular assembly of a plurality of granular activated carbon filters, hereinafter referred to as “carbon tanks”.

It is preferable, but not required, that one or more of the intermediate treatment processes provide aeration. Alternatively, the DBP treatment system may optionally further comprise a separate aeration treatment phase that occurs prior to the carbon filtration phase. A predetermined minimum contact time from the time the chlorine is added during the pre-chlorination phase to the start of the carbon filtration phase is required to achieve a sufficient formation of DBPs. The modular assembly of the plurality of carbon tanks allow for scalability as well as periodic maintenance of one or more carbon tanks without imposing significant disruptions to the operation of the MDWTP.

The DBP treatment system described herein is highly effective in removing a majority of DBP precursors prior to distribution. Such removal of DBP precursors allows for a reduced concentration of disinfectant to be added to the drinking water during the disinfection phase, which in turn allows for added benefits, such as more reliable compliance of the EPA's residual disinfectant requirements that must be maintained throughout distribution.

### BRIEF DESCRIPTION OF THE DRAWINGS

FIG. 1 is a schematic flowchart of an exemplary, nonlimiting embodiment of a water treatment and filtration system comprising a plurality of steps which include collection of raw water, pre-chlorination treatment, screening, one or more intermediate treatment processes, carbon filtration, disinfection, and distribution.

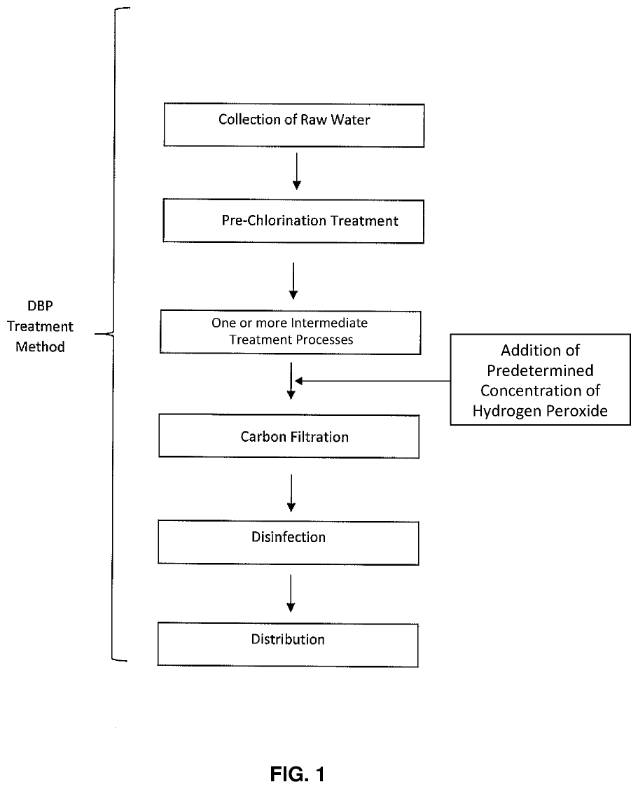

FIG. 2 is a schematic flowchart of the exemplary, nonlimiting embodiment of the water treatment and filtration system illustrating an optional step comprising storage of the water after disinfection and before distribution.

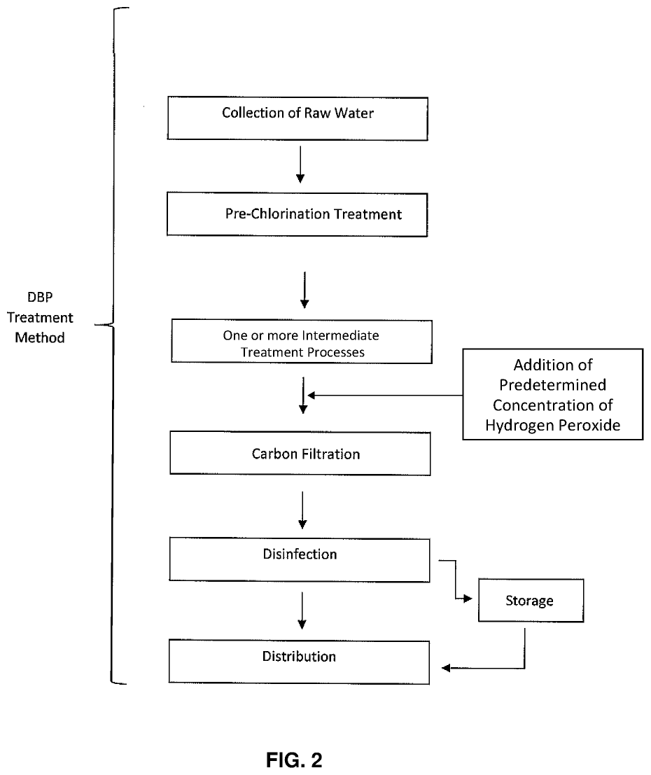

FIG. 3 is a schematic flowchart of an alternative exemplary, nonlimiting embodiment of the water treatment and filtration system comprising a plurality of steps, including collection of raw water, pre-chlorination treatment, screening, one or more intermediate treatment processes, aeration, carbon filtration, disinfection, and distribution.

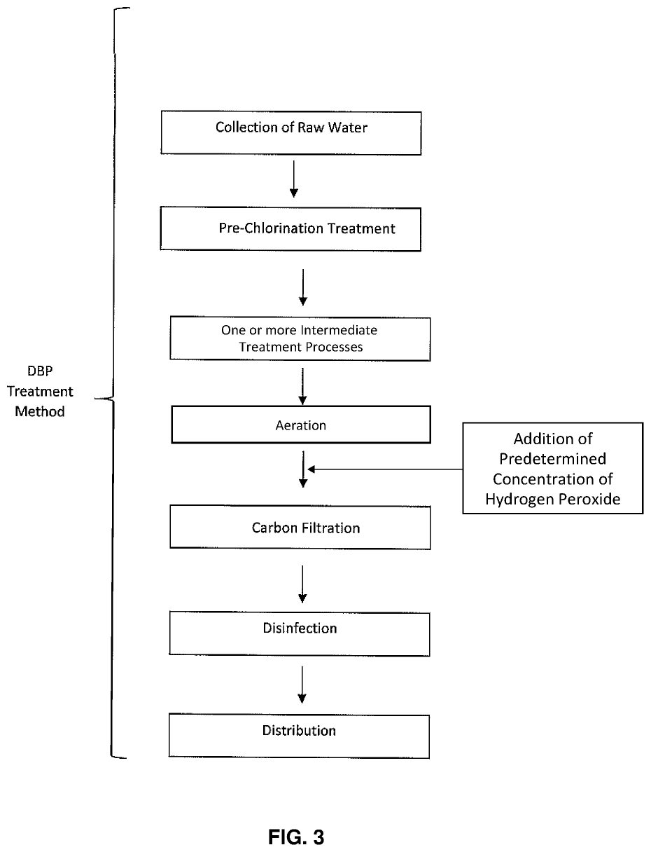

FIG. 4 is a schematic flowchart of the alternative exemplary, nonlimiting embodiment of the water treatment and filtration system illustrating an optional step comprising storage of the water after disinfection and before distribution.

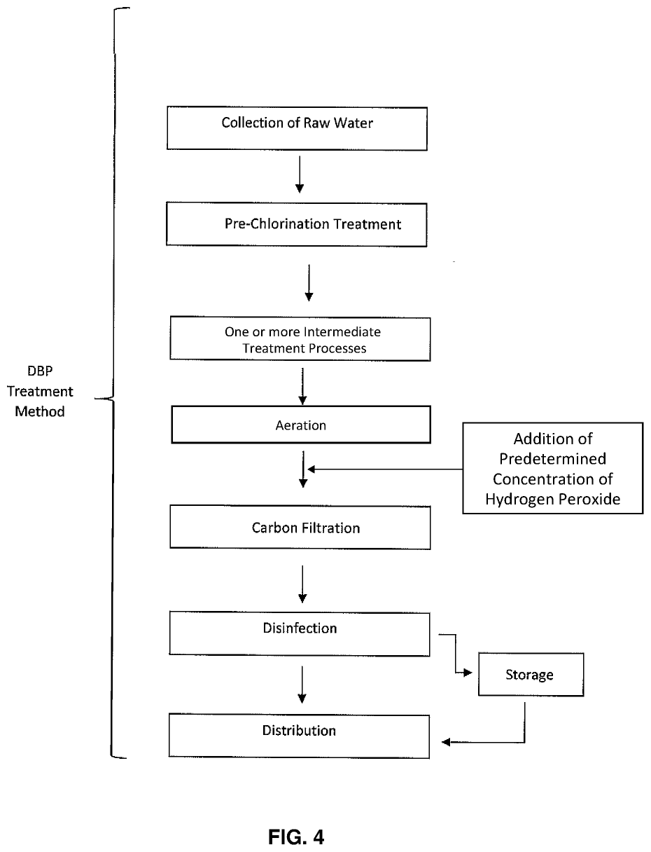

FIG. 5 is a schematic diagram showing the exemplary, nonlimiting embodiment of the water treatment and filtration system comprising a plurality of phases, including a collection phase, a pre-chlorination phase, an intermediate treatment phase, a carbon filtration phase, a disinfection phase, and a distribution phase wherein a modular assembly of a plurality of carbon tanks are retrofitted to an existing municipal drinking water treatment plant.

FIG. 6 is a schematic diagram showing the alternative exemplary, nonlimiting embodiment of the water treatment and filtration system comprising a plurality of phases, including a collection phase, a pre-chlorination phase, an intermediate treatment phase, an aeration treatment phase, a carbon filtration phase, a disinfection phase, and a distribution phase wherein a modular assembly of a plurality of carbon tanks are retrofitted to an existing municipal drinking water treatment plant.

### NUMBERING REFERENCE

1—DBP treatment system
5—Influent source
10—Screening
11—Sediment Filter
15—Pre-chlorination treatment
20—Intermediate treatment processes
21—Aeration Mechanism
25—Plurality of carbon tanks
26a—Main influent conduit
26b—Main effluent conduit
26c—Carbon filtration bypass
27a—Plurality of influent branch conduits
27b—Plurality of effluent branch conduits
28—Plurality of backwashing discharge conduits
29—Drain field
30—Disinfection
35—Storage
40—Distribution
45—POU
50—Collection phase
55—Pre-chlorination phase
60—Intermediate treatment phase
61—Aeration treatment phase
65—Carbon filtration phase
70—Disinfection phase
75—Distribution phase

### DETAILED DESCRIPTION OF THE EMBODIMENTS

An exemplary, nonlimiting embodiment of the invention relates to a novel water treatment and filtration system for reducing disinfection byproducts, hereinafter the “DBP treatment system” 1, which reduces the concentration levels of a variety of disinfection byproducts, hereinafter referred to as “DBPs”, in drinking water at its point-of-use, hereinafter referred to as “POU” 45, by preemptively removing DBP precursors prior to disinfection 30 of said drinking water. The variety of DBPs may include haloacetic acids (HAAS), trihalomethanes (THM), chloroform, or bromoform. Haloacetic acids may comprise dibromoacetic acid, dichloroacetic acid, monobromoacetic acid, monochloroacetic acid, or trichloroacetic acid. Trihalomethanes may comprise trichloromethane, dibromochloromethane, bromodichloromethane, or tribromomethane.

The DBP treatment system 1 is easily integrated within existing municipal drinking water treatment plants, hereinafter referred to as “MDWTPs”. The DBP treatment system 1 can be retrofitted within MDWTPs that may already be using a variety of conventional treatment processes, such as coagulation, flocculation, sedimentation, filtration, or disinfection.

The DBP treatment system 1 comprises a plurality retrofitted subsystems and a plurality of subsystems provided by the MDWTP. The plurality of retrofitted subsystems comprises a pre-chlorination subsystem 55 and a carbon filtration subsystem 65. The plurality of subsystems provided by the MDWTP comprise a collection subsystem 50, a plurality of intermediate treatment subsystems 60, a carbon filtration subsystem 65, a disinfection subsystem 70, and a distribution subsystem 75. Each of the subsystems comprised within the plurality retrofitted subsystems and plurality of subsystems provided by the MDWTP respectively provide a distinct phase of the DBP treatment system 1.

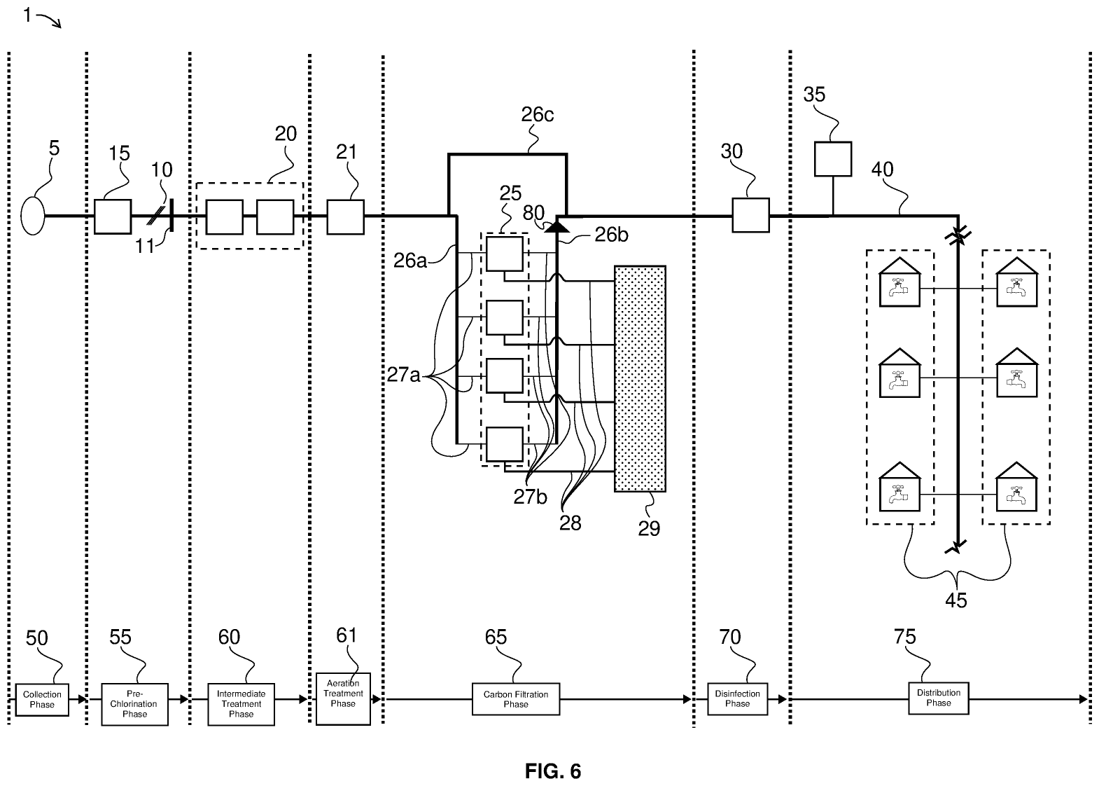

As shown in FIG. 6, an alternative embodiment of the DBP treatment system 1 comprises a plurality retrofitted subsystems which further comprises an aeration treatment subsystem 61. The aeration treatment subsystem 61 is preferably provided downstream of the plurality of intermediate treatment subsystems 60. The aeration treatment subsystem 61 comprises an aeration mechanism 21 which aerates the water.

The collection subsystem 50 comprises an influent source intake conduit and one or more water pumps. The influent source intake conduit fluidly couples the one or more water pumps to the influent source 5. The one or more water pumps pump the raw water provided by the influent source 5 through the influent source intake conduit and into the downstream subsystems. The influent source 5 may comprise groundwater or surface water.

After the collection phase, the raw water proceeds downstream to the pre-chlorination phase. The pre-chlorination subsystem 55, comprises a pre-chlorination holding tank and a pre-chlorination treatment 15. The pre-chlorination treatment 15 comprises dosing the raw water with a predetermined concentration of sodium hypochlorite, chlorine gas, or using an alternative EPA acceptable chlorination method. The pre-chlorination tank assists with storing liquid or gas used for the pre-chlorination treatment 15 and is fluidly coupled to the influent source intake conduit. Chlorine ions are highly reactive with various DBP precursors, which comprise a variety of compounds, including natural organic matter (“NOM”). The pre-chlorination subsystem 55 may also comprise a screening treatment, hereinafter referred to as “screening” 10, of the water after the pre-chlorination treatment.

Screening 10, which comprises one or more coarse or fine screens, is effective in reducing the NOM concentration in the water prior to the water reaching the intermediate treatment phase 60. Reducing the NOM in the water may assist in reducing the concentration of DBP precursors. Furthermore, it is also anticipated that one or more sediment filters 11 may also be utilized as part of the screening 10 to reduce the turbidity of the water.

Following the pre-chlorination phase, the water proceeds to the plurality of intermediate treatment subsystems 60 which are provided by the MDWTP. The plurality of intermediate treatment subsystems 60 provides one or more intermediate treatment processes 20, which comprise a plurality of physical or chemical treatments, such as coagulation, flocculation, or sedimentation. The DBP treatment system 1 requires that the plurality of intermediate treatment phases precede the carbon filtration phase. A predetermined minimum contact time of at least one hour is required between the time the raw water undergoes the pre-chlorination treatment 15 and beginning of the carbon filtration phase. The predetermined minimum contact time allows for DBPs to adequately form in the water prior to filtration during the carbon filtration phase.

It is anticipated that one or more of the intermediate treatment processes 20 provided by the MDWTP may aerate the water during one or more of the intermediate treatment phases. It is further anticipated that the DBP treatment system 1 may further comprise an optional aeration treatment subsystem 61 downstream from the plurality of intermediate treatment subsystems 60 and before the carbon filtration subsystem 65. The aeration treatment subsystem 61 comprises an aeration mechanism 21.

Aeration of the water is an effective treatment for removing chloroform and other dissolved gases in the water. It is preferable that at least fifty percent (50%) of the chloroform in the water, which forms as a byproduct from the pre-chlorination treatment 15 of the raw water provided by the pre-chlorination subsystem 55, be removed from the water prior to the water reaching the carbon filtration subsystem 65 in order to reduce maintenance of the DBP treatment system 1.

The carbon filtration subsystem 65 is located downstream relative to the plurality of intermediate treatment subsystems 60. The carbon filtration subsystem 65 is also located downstream relative to the aeration treatment subsystem 61, if the DBP treatment system 1 comprises the aeration treatment subsystem 61. The carbon filtration subsystem 65 comprises a modular assembly of a plurality of carbon tanks 25. The modular assembly of the plurality of carbon tanks 25 are configured to the DBP treatment system 1 to easily scale as well as be progressively retrofitted to a MDWTP. The DBP treatment system 1 preferably utilizes activated carbon as a filter media within each of the plurality of carbon tanks 25. It is anticipated that other types of filter media may also be utilized in addition to activated carbon within each carbon tank.

The utilization of the plurality of carbon tanks 25 allow for periodic maintenance of one or more carbon tanks without imposing significant disruptions to the operation of the MDWTP. Such periodic maintenance may require temporarily discontinuing the operation of one or more carbon tanks. It is important that periodic maintenance not shutdown or significantly disrupt the operation of a MDWTP. The modular assembly of the plurality of carbon tanks 25 are configured to minimize disruption to the operation of the MDWTP as one or more carbon tanks may be taken out of operation for maintenance without requiring the entire MDWTP be shutdown.

The DBP treatment system 1 requires the pre-chlorination treatment 15 preferably use sodium hypochlorite or chlorine gas. When using sodium hypochlorite or chlorine gas for the pre-chlorination treatment 15, a predetermined dose ranging from about 1 milligram per liter (mg/L) to about 7 mg/L is required and varies depending on the concentration of NOM and other DBP precursors in the raw water. The predetermined dose of sodium hypochlorite, or chlorine gas, used for the pre-chlorination treatment 15 is largely dependent upon the breakpoint chlorination of the raw water provided by the influent source 5. Determining breakpoint chlorination of the raw water requires a thorough understanding of a variety of water quality characteristics of the water. As such, accurate water quality characteristics of the raw water, as well as the water within the main influent conduit 26a and each effluent branch conduit 27b, must be determined in order to determine a proper dose of sodium hypochlorite, or chlorine gas, for the pre-chlorination treatment 15.

The water quality characteristics which need to be known include total organic carbon (“TOC”), dissolved organic carbon (“DOC”), total dissolved solids (“TDS”), pH, concentration of sulfides, and total iron. The DBP treatment system 1 requires such water quality characteristics be within a predetermined range or less than a predetermined threshold, depending on the particular water quality characteristic. The DBP treatment system 1 requires that the water comprise the following water quality characteristics prior to entering any of the influent branch conduits during the carbon filtration subsystem 65: TOC is not greater than approximately 3 mg/L, DOC is not greater than approximately 3 mg/L, TDS not greater than approximately 500 mg/L, pH is within a range of approximately 6 to approximately 8, concentration of sulfides not greater than approximately 1 mg/L, and concentration of total iron is not greater than approximately 1 mg/L.

The water quality characteristics, as enumerated above, ensure that the DBP precursors within the raw water are able to sufficiently react with the chlorine ions provided by the pre-chlorination treatment 15 and subsequently form DBPs prior to the water entering the carbon filtration phase.

Activated carbon does not effectively filter DBP precursors from water as the activated carbon fails to significantly adsorb DBP precursors. However, when DBP precursors react with chlorine ions to form DBPs, activated carbon becomes a much more effective adsorbent and are able to filter a substantial portion of the DBP precursors from the water. Allowing the chlorine ions provided by the pre-chlorination treatment 15 to react with the DBP precursors in the water for not less than the predetermined minimum contact time ensures the formation of DBPs are sufficiently produced. The DBP treatment system 1 cleverly utilizes the formation of DBPs prior to the water reaching the carbon filtration phase to successfully remove the DBP precursors. Removal of said DBP precursors prior to the disinfection phase 70 prevents the formation of DBPs within the distribution phase 75 and in turn reduces the concentration of DBPs at the POU 45.

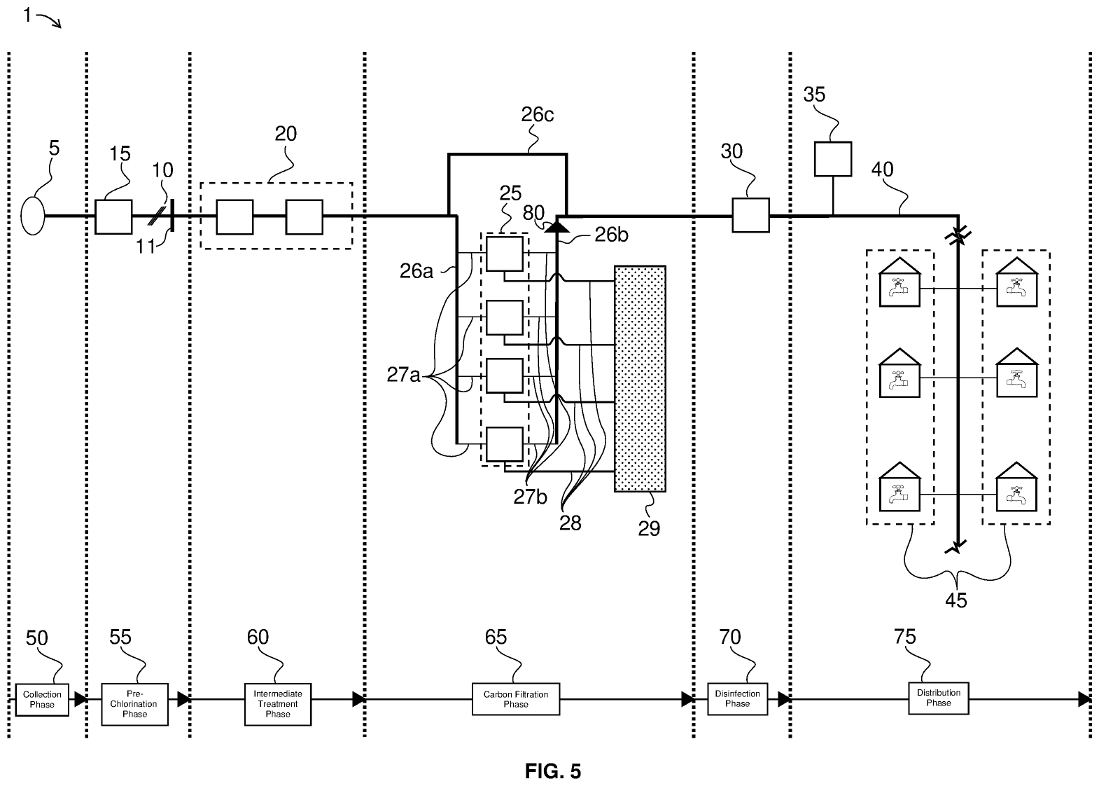

The modular assembly of the plurality of carbon tanks 25 are fluidly coupled to the MDWTP by a plurality of water conduits. The plurality of water conduits comprises a main influent water conduit 26a, a plurality of influent branch conduits 27a, a plurality of effluent branch conduits 27b, and a main effluent conduit 26b. The plurality of influent branch conduits 27a fluidly connect the main influent conduit 26a to the plurality of carbon tanks 25. Similarly, the plurality of effluent branch conduits 27b fluidly connect the main effluent conduit 26b to the plurality of carbon tanks 25. The carbon filtration phase 65 substantially begins when water enters the main influent conduit 26a. The main influent conduit 26a diverts water which has completed its treatment during the plurality of intermediate treatment phases to the carbon filtration subsystem 65. As shown in FIGS. 5 and 6, the main effluent conduit 26b, which is fluidly coupled to the plurality of carbon tanks 25, routes the water to the disinfection subsystem 70.

Each carbon tank of the plurality of carbon tanks 25 is fluidly connected to one another, preferably in parallel as shown in FIGS. 5 and 6. Fluidly coupling the plurality of carbon tanks 25 in parallel enables the addition or removal of one or more carbon tanks of the plurality of carbon tanks 25 from service without impacting the operation of the other carbon tanks.

The DBP treatment system 1 requires that during normal operation the flow rate of water through each carbon tank be limited to a maximum flow rate of about 2 gallons per minute per cubic foot (gpm/ft³), hereinafter referred to as the “restricted flow rate.” A flow rate exceeding the restricted flow rate within the plurality of carbon tanks 25 results in premature degradation of the filter media. To ensure the restricted flow rate is achieved, the DBP treatment system 1 utilizes one or more flow restrictors 80, as schematically shown in FIGS. 5 and 6, which are installed on the main effluent conduit 26b. Additionally, to prevent adequate access of water during emergency events, a carbon filtration bypass 26c is provided by the DBP treatment system 1, as shown in FIGS. 5 and 6. Water which is diverted through the carbon filtration bypass 26c circumvents the plurality of carbon tanks 25 and the one or more flow restrictors 80.

Regarding periodic maintenance of the carbon tanks 25, the DBP treatment system 1 requires each carbon tank of the plurality of carbon tanks 25 be backwashed and then subsequently rinsed on a substantially periodic frequency. Backwashing a carbon tank is accomplished by reversing the internal directional flow of the influent within the carbon tank. It is preferable that backwashing of each carbon tank of the plurality of carbon tanks 25 be performed on a weekly basis. However, backwashing of one or more carbon tanks may be performed more frequently depending on a variety of parameters. The duration of backwashing for each carbon tank must take place for at 10 seconds per cubic foot of filter media within the carbon tank. The flow rate of the water used during backwashing is greater than the restricted flow rate.

The variety of parameters used to determine if the frequency with which backwashing of one or more of the plurality of carbon tanks 25 occurs comprises the concentration of free chlorine within the main influent conduit 26a, the concentration of free chlorine measured within each effluent branch conduit 27b, the concentration of DBPs in the water in the main influent conduit 26a, the concentration of DBPs in the water in each effluent branch conduit 27b, and the flow rate at which the water travels through each respective carbon tank.

The concentration of free chlorine in the water in the main influent conduit 26a must be at least 0.2 mg/L and is preferably not greater than about 0.5 mg/L. If the concentration of free chlorine in the main influent conduit 26a is less than 0.2 mg/L, bacteria may cultivate within one or more of the plurality of carbon tanks 25. If the concentration of free chlorine in the water in the main influent conduit 26a is greater than about 0.5 mg/L, the frequency with which backwashing of the plurality of carbon tanks 25 occurs may need to increase.

During normal operation of the DBP treatment system 1, the free chlorine in an effluent branch conduit should be preferably less than 0.2 mg/L and not greater than 0.5 mg/L. A free chlorine concentration greater than 0.5 mg/L in an effluent branch conduit is indicative of the respective carbon tank being loaded and in need of backwashing or other maintenance. Accordingly, the DBP treatment system 1 requires monitoring the concentration of free chlorine in the water in the main influent conduit 26a as well as each of the effluent branch conduits to determine if the one or more carbon tanks are in need of backwashing.

It is anticipated that a predetermined dose of hydrogen peroxide (H₂O₂) may optionally be added to the water in the main influent conduit 26a, prior to the water entering into any of the influent branch conduits 27a, to reduce the concentration of free chlorine in the water and thereby reduce the frequency with which backwashing the plurality of carbon tanks 25 must occur. The predetermined dose of hydrogen peroxide (H₂O₂) which may be optionally added to the water in the main influent conduit 26a preferably ranges from approximately 0.2 mg/L to approximately 0.8 mg/L. Adding the predetermined dose of hydrogen peroxide to the water in the main influent conduit 26a improves the oxidation effect of the activated carbon within the plurality of carbon tanks 25.

Effluent generated during the backwashing of one or more carbon tanks is discharged from the one or more carbon tanks through one or more backwashing discharge conduits of a plurality of backwashing discharge conduits 28. The plurality of backwashing discharge conduits 28 fluidly connects the plurality of carbon tanks 25 to a drain field 29, as shown in FIGS. 5 and 6.

After the backwashing of one or more carbon tanks is completed, the directional flow of water moving through each of the one or more carbon tanks being backwashed is reverted to its normal operational directional flow and then the one or more carbon tanks are then rinsed for at least 8 seconds per cubic foot of filter media within the carbon tank. The effluent of the subsequent rinsing of the one or more carbon tanks must also be discharged to the drainage field through each carbon tank's respective backwashing discharge conduit, as shown in FIGS. 5 and 6.

The DBP treatment system 1 is highly effective in removing a majority of DBP precursors prior to the water reaching the disinfection subsystem 70. Such effective removal of DBP precursors allows for reduced concentrations of disinfectant, which often comprises chlorine, to be added to the drinking water prior to the distribution phase. Consequently, the DBP treatment system 1 allows for more reliable compliance of the EPA's maximum residual disinfectant level requirement that identifies acceptable concentration levels of disinfectants within drinking water as a result of less DBP precursors being present and consequently reacting with the disinfectant added by the disinfection subsystem 70.

The distribution subsystem 75 comprises a network of distribution conduits which fluidly couple the water treated leaving the MDWTP to each POU 45, as schematically shown in FIGS. 5 and 6. It is further anticipated that some MDWTPs may comprises clear wells or other holding tanks, hereinafter referred to as “storage” 35, prior to the drinking water being distributed to the POUs 45.

While the exemplary, nonlimiting embodiment of the invention has been disclosed, certain modifications may be made by those skilled in the art to modify the invention without departing from the spirit of the invention.

The invention claimed is:

1. A water treatment and filtration system for reducing disinfection byproducts comprising:
a. a municipal drinking water treatment plant;
wherein the municipal drinking water treatment plant comprises a collection subsystem, a plurality of intermediate treatment subsystems, a disinfection subsystem, and a distribution subsystem;
wherein the collection subsystem provides an influent source intake conduit;
wherein the influent source intake conduit is fluidly coupled to an influent source;
b. a pre-chlorination subsystem;
wherein the pre-chlorination subsystem is provided downstream from the collection subsystem and upstream from the plurality of intermediate treatment subsystems;
wherein the pre-chlorination subsystem comprises a pre-chlorination holding tank;
wherein the pre-chlorination holding tank is fluidly coupled to the influent source intake conduit;
c. a carbon filtration subsystem;
wherein the carbon filtration subsystem comprises a modular assembly of a plurality of carbon tanks;
wherein the carbon filtration subsystem is provided downstream from the plurality of intermediate treatment subsystems and upstream from the disinfection subsystem;
wherein the carbon filtration subsystem further comprises a main influent conduit, a plurality of influent branch conduits, a plurality of effluent branch conduits, a main effluent conduit, one or more flow restrictors, a carbon filtration bypass, a plurality of backwashing discharge conduits, and a drain field;
wherein the main influent conduit fluidly couples the effluent of the plurality of intermediate treatment subsystems to the plurality of influent branch conduits;
wherein each influent branch conduit of the plurality of influent branch conduits is fluidly coupled to the main influent conduit and a distinct carbon tank of the plurality of carbon tanks;
wherein each effluent branch conduit is fluidly coupled to the main effluent conduit and a distinct carbon tank of the plurality of carbon tanks;
wherein the main effluent conduit is fluidly coupled to the plurality of effluent branch conduits and the disinfection subsystem;
wherein the one or more flow restrictors are fluidly coupled to the main effluent conduit;
wherein each backwashing discharge conduit of the plurality of backwashing discharge conduits fluidly couples a distinct carbon tank of the plurality of carbon tanks to the drain field; and
wherein the carbon filtration bypass fluidly connects the effluent of the plurality of intermediate treatment subsystems to the disinfection subsystem.

2. The water treatment and filtration system for reducing disinfection byproducts as described in claim 1, further comprising an aeration treatment subsystem;
wherein the aeration treatment subsystem is located downstream relative to the plurality of intermediate treatment subsystems.

3. The water treatment and filtration system for reducing disinfection byproducts as described in claim 1, wherein the plurality of carbon tanks are fluidly coupled to the main influent conduit and main effluent conduit in parallel.

4. A method of using the water treatment and filtration system for reducing disinfectant byproducts, the method comprising:
a. collecting raw water with a collection subsystem provided by a municipal drinking water treatment plant;
b. dosing the raw water with a predetermined dose of a pre-chlorination treatment;
c. providing a plurality of intermediate treatment processes provided by the municipal drinking water treatment plant;
d. dosing the water within the main influent conduit with a predetermined dose of hydrogen peroxide;
e. filtering the water with a carbon filtration subsystem;
f. disinfecting the water with a disinfection subsystem provided by the municipal drinking water treatment plant; and
g. distributing the effluent of the municipal drinking water treatment plant to its point of use with a distribution subsystem provided by the municipal drinking water treatment plant.

5. The method of using the water treatment and filtration system for reducing disinfectant byproducts as described in claim 4, wherein the predetermined dose of the pre-chlorination treatment comprises a concentration of 1 mg/L-7 mg/L of sodium hypochlorite.
